(19) United States
(12) Patent Application Publication
(10) Pub. No.: US 2026/0149177 A1
(43) Pub. Date: May 28, 2026

(54) ANTENNA MODULE

(71) Applicant: PEGATRON CORPORATION, TAIPEI CITY (TW)

(72) Inventors: Chin-Ting Huang, Taipei City (TW); Yu-Hsuan Lin, Taipei City (TW)

(73) Assignee: PEGATRON CORPORATION, TAIPEI CITY (TW)

(21) Appl. No.: 19/382,182

(22) Filed: Nov. 6, 2025

(30) Foreign Application Priority Data
Nov. 22, 2024 (TW) 113145048

(51) Int. Cl. H01Q 9/04

(52) U.S. Cl. CPC H01Q 9/0421; H01Q 9/0442

(57) ABSTRACT

An antenna module includes a main radiator, a feeding radiator, first and second grounding radiators, a first tilting radiator, and a pattern adjusting radiator. The main radiator includes a first open end. The feeding radiator, first and second grounding radiators, and first tilting radiator are bendably connected to main radiator. First tilting radiator has a second open end away from main radiator, is at an opposite side relative to first grounding radiator and feeding radiator, and forms a first non-zero angle with a normal direction of main radiator. Second grounding radiator is at an opposite side relative to first open end. The pattern adjusting radiator is beside the first open end, separated from first open end, and includes a matching radiator and a second tilting radiator. The matching radiator is close to first open end. A second non-zero angle is formed between the second tilting radiator and the normal direction.

### CROSS-REFERENCE TO RELATED APPLICATION

This application claims the priority benefit of Taiwan application serial no. 113145048, filed on Nov. 22, 2024. The entirety of the above-mentioned patent application is hereby incorporated by reference herein and made a part of this specification.

### BACKGROUND

### Technical Field

The disclosure relates to an antenna module, and particularly relates to an antenna module that may enhance the angle range of radiation pattern.

### Related Art

Generally speaking, current planar inverted-f antennas (PIFA) have gain less than −2 dBi in the 150-degree radiation pattern, which cannot meet the requirements of the industry for 5G open radio access network (O-RAN) built-in antennas. Therefore, how to enhance the angle range of radiation pattern of planar inverted-F antennas to meet the requirements of 5G O-RAN is an issue that this field is dedicated to exploring.

### SUMMARY

The disclosure provides an antenna module that may enhance the angle range of radiation pattern.

An antenna module of the disclosure includes a main radiator, a feeding radiator, a first grounding radiator, a first tilting radiator, a second grounding radiator, and a pattern adjusting radiator. The main radiator includes a first open end. The feeding radiator is bendably connected to the main radiator. The first grounding radiator is bendably connected to the main radiator. The first tilting radiator is bendably connected to the main radiator and has a second open end away from the main radiator, the first tilting radiator is located at an opposite side relative to the first grounding radiator and the feeding radiator, and a first non-zero angle is formed between the first tilting radiator and a normal direction of the main radiator. The second grounding radiator is bendably connected to the main radiator and is located at an opposite side relative to the first open end. The pattern adjusting radiator is located beside the first open end and is separated from the first open end, and the pattern adjusting radiator includes a matching radiator and a second tilting radiator connected to each other. The matching radiator is close to the first open end. A second non-zero angle is formed between the second tilting radiator and the normal direction.

In an embodiment of the disclosure, the antenna module resonates at a first frequency, and a path length from the second open end, the main radiator to the first grounding radiator is two-quarters wavelength of the first frequency.

In an embodiment of the disclosure, the antenna module resonates at a second frequency, and a path length from the first open end, the main radiator to the second grounding radiator is three-quarters wavelength of the second frequency.

In an embodiment of the disclosure, the second tilting radiator is grounded at a location away from the matching radiator.

In an embodiment of the disclosure, the first non-zero angle and the second non-zero angle are different or the same, and each of the first non-zero angle and the second non-zero angle is less than 90 degrees.

In an embodiment of the disclosure, the distance between the matching radiator and the first open end is greater than 0 centimeter and less than 3 centimeters.

In an embodiment of the disclosure, the main radiator is polygonal, circular, or elliptical.

In an embodiment of the disclosure, the main radiator is rectangular and includes a first side, a second side, a third side, and a fourth side sequentially connected, the first open end is located at the first side, the feeding radiator and the first grounding radiator are connected to the second side, the second grounding radiator is connected to the third side, and the first tilting radiator is connected to the fourth side.

In an embodiment of the disclosure, the feeding radiator, the first grounding radiator, and the second grounding radiator are perpendicular to the main radiator, and the first grounding radiator is perpendicular to the second grounding radiator.

In an embodiment of the disclosure, the frequency band resonated by the antenna module is in a range of 3.3 GHz to 4.2 GHz.

Based on the above, the antenna module of the disclosure includes a main radiator, a feeding radiator, a first grounding radiator, a first tilting radiator, a second grounding radiator, and a pattern adjusting radiator. The disclosure increases the angle range of radiation pattern by the tilted disposition of the first tilting radiator and the second tilting radiator of the pattern adjusting radiator. Accordingly, the antenna module of the disclosure may enhance the angle range of radiation pattern.

### BRIEF DESCRIPTION OF THE DRAWINGS

FIG. 1 is a schematic diagram of an antenna module according to an embodiment of the disclosure.

FIG. 2 is a relationship diagram of frequency and S11 of the antenna module in FIG. 1.

FIG. 3A is an XZ plane pattern diagram of the antenna module in FIG. 1 at 3.7 GHz.

FIG. 3B is a YZ plane pattern diagram of the antenna module in FIG. 1 at 3.7 GHz.

### DESCRIPTION OF THE EMBODIMENTS

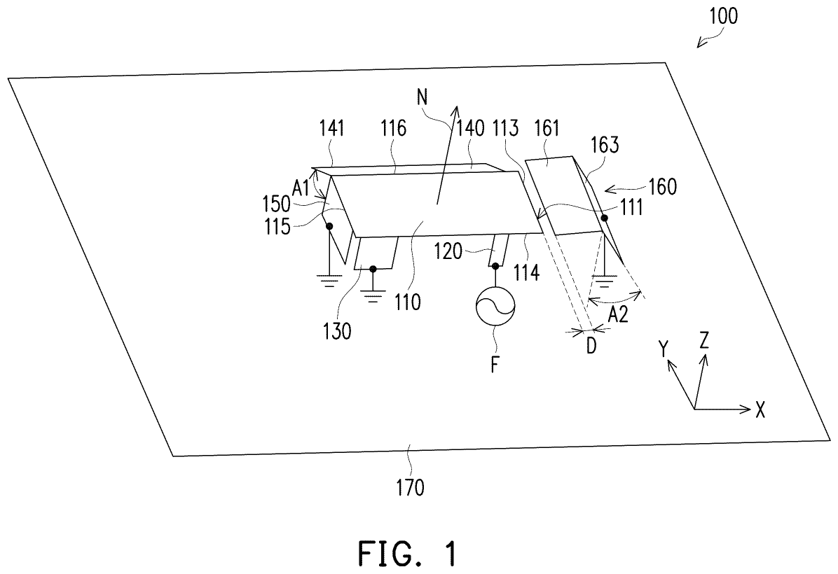

FIG. 1 is a schematic diagram of an antenna module according to an embodiment of the disclosure. Refer to FIG. 1, an antenna module 100 of this embodiment includes a main radiator 110, a feeding radiator 120, a first grounding radiator 130, a first tilting radiator 140, a second grounding radiator 150, and a pattern adjusting radiator 160.

Referring to FIG. 1, in detail, the main radiator 110 includes a first open end 111. The feeding radiator 120 is bendably connected to the main radiator 110 and connected to a signal feed source F. The first grounding radiator 130 is bendably connected to the main radiator 110. The first tilting radiator 140 is bendably connected to the main radiator 110 and has a second open end 141 away from the main radiator 110. The first tilting radiator 140 is located at an opposite side relative to the first grounding radiator 130 and the feeding radiator 120, and a first non-zero angle A1 is formed between the first tilting radiator 140 and a normal direction N of the main radiator 110.

Referring to FIG. 1 still, the second grounding radiator 150 is bendably connected to the main radiator 110 and located at an opposite side relative to the first open end 111. The pattern adjusting radiator 160 is located beside the first open end 111 and separated from the first open end 111. The pattern adjusting radiator 160 includes a matching radiator 161 and a second tilting radiator 163 connected to each other. The matching radiator 161 is close to the first open end 111. A second non-zero angle A2 is formed between the second tilting radiator 163 and the normal direction N. The second tilting radiator 163 is grounded at a location away from the matching radiator 161.

In this embodiment, the first grounding radiator 130, the second grounding radiator 150, and the second tilting radiator 163 are respectively connected to a metal grounding plane 170, and the main radiator 110, the feeding radiator 120, the first grounding radiator 130, the first tilting radiator 140, the second grounding radiator 150, the pattern adjusting radiator 160, and the metal grounding plane 170 are all formed by conductive material.

In this embodiment, the first non-zero angle A1 and the second non-zero angle A2 are the same, and each of the first non-zero angle A1 and the second non-zero angle A2 is less than 90 degrees. For example, the first non-zero angle A1 and the second non-zero angle A2 are both 60 degrees, but the disclosure is not limited thereto. In other embodiments, the first non-zero angle A1 and the second non-zero angle A2 may also be different.

It is worth mentioning that the antenna module 100 of this embodiment may enhance the angle range of the radiation pattern by the tilted disposition of the first tilting radiator 140 and the second tilting radiator 163, and may address the issue that the open end causes smaller current and weaker radiation energy due to larger resistance. In this embodiment, the first tilting radiator 140 may enhance the radiation pattern on an axis X, and the second tilting radiator 163 may enhance the radiation pattern on an axis Y.

Furthermore, in this embodiment, the antenna module 100 may adjust the distance between the feeding radiator 120 and the first grounding radiator 130, so that the resistance at resonance point of the signal feed source F is 50 ohms, and the reactance may approach zero to achieve good resistance matching and excite electromagnetic wave radiation to transmit signals. Moreover, the antenna module 100 of this embodiment may also adjust the resistance matching of the antenna module 100 by adjusting the length and width dimensions of the matching radiator 161.

In this embodiment, the frequency band resonated by the antenna module 100 is in a range of 3.3 GHz to 4.2 GHz to comply with the specifications of 5G open radio access network (O-RAN). In detail, the antenna module 100 of this embodiment resonates at a first frequency and a second frequency. The path length from the second open end 141, the main radiator 110 to the first grounding radiator 130 is two-quarters wavelength of the first frequency. The path length from the first open end 111, the main radiator 110 to the second grounding radiator 150 is three-quarters wavelength of the second frequency. In this embodiment, the first frequency is, for example, 3.3 GHz, and the second frequency is, for example, 3.95 GHz, but the disclosure is not limited thereto.

The structure of the antenna module 100 of this embodiment is described in detail below.

Referring to FIG. 1, the main radiator 110 of this embodiment is rectangular and includes a first side 113, a second side 114, a third side 115, and a fourth side 116 sequentially connected. The first open end 111 is located at the first side 113. The feeding radiator 120 and the first grounding radiator 130 are connected to the second side 114. The second grounding radiator 150 is connected to the third side 115. The first tilting radiator 140 is connected to the fourth side 116. In other embodiments, the main radiator 110 may also be polygonal, circular, or elliptical, and the disclosure is not limited thereto.

Referring to FIG. 1, the feeding radiator 120, the first grounding radiator 130, and the second grounding radiator 150 are perpendicular to the main radiator 110. The first grounding radiator 130 is perpendicular to the second grounding radiator 150. The second tilting radiator 163 and the first tilting radiator 140 are perpendicular to each other.

Referring to FIG. 1, a distance D between the matching radiator 161 and the first open end 111 is greater than 0 centimeter and less than 3 centimeters. In this embodiment, the distance D between the matching radiator 161 and the first open end 111 is, for example, 0.5 centimeters, but the disclosure is not limited thereto.

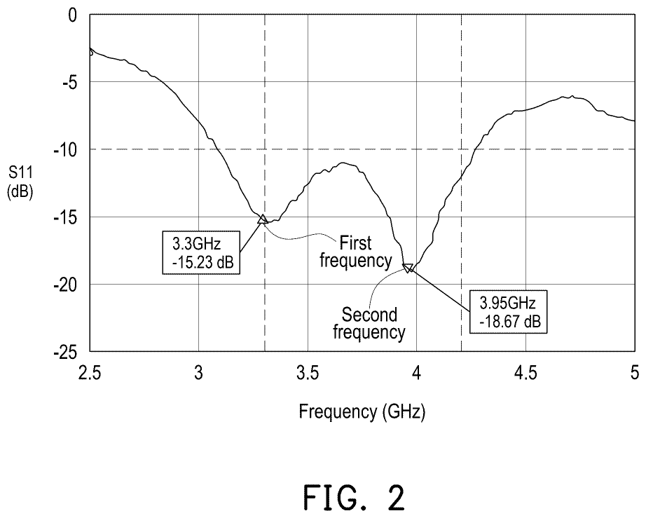

FIG. 2 is a relationship diagram of frequency and S11 of the antenna module in FIG. 1. Referring to FIG. 2, when the first frequency is 3.3 GHz and the second frequency is 3.95 GHz, under the condition that the input resistance bandwidth takes VSWR of 1.9:1 or S11 of −10 dB as the standard, the operating bandwidth of the antenna module 100 of this embodiment may satisfy the required bandwidth of n48 (3.55 GHz-3.7 GHz), n77 (3.3 GHz-4.2 GHz), and n78 (3.3 GHz-3.8 GHz) of 5G O-RAN.

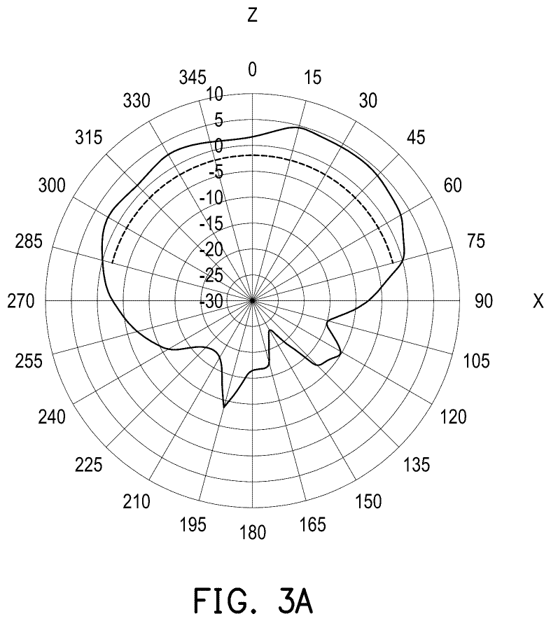

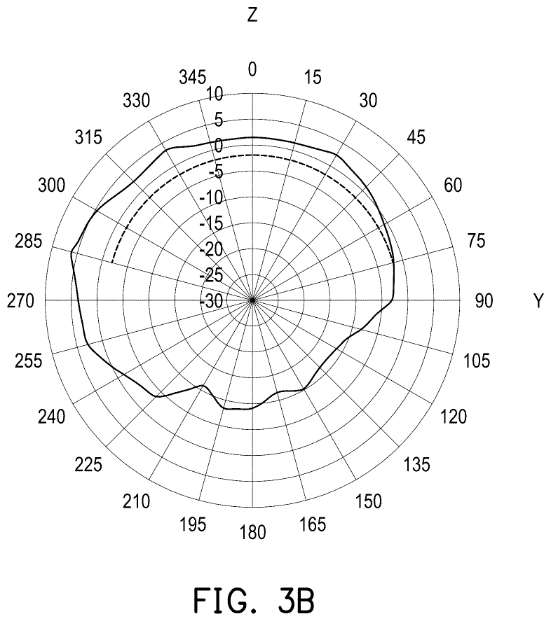

FIG. 3A is an XZ plane pattern diagram of the antenna module in FIG. 1 at 3.7 GHz. FIG. 3B is a YZ plane pattern diagram of the antenna module in FIG. 1 at 3.7 GHz. Referring to FIG. 3A and FIG. 3B, from the ETS-Lindgren 3D chamber measurement of 2D pattern, it may be known that when the operating frequency of the antenna module 100 of this embodiment is at 3.7 GHz MHz, the peak gain is 6.5 dBi and the antenna efficiency is −1.8 dB. That is to say, the gain of the antenna module 100 of this embodiment in the 150-degree radiation pattern of both the XZ plane pattern and the YZ plane pattern is greater than −2 dBi, which may meet the requirements of 5G O-RAN.

In summary, the antenna module of the disclosure includes a main radiator, a feeding radiator, a first grounding radiator, a first tilting radiator, a second grounding radiator, and a pattern adjusting radiator. The disclosure increases the angle range of radiation pattern by disposing the first tilting radiator and the second tilting radiator of the pattern adjusting radiator in a tilted design. Accordingly, the antenna module of the disclosure may enhance the angle range of radiation pattern.

What is claimed is:

1. An antenna module, comprising:
a main radiator comprising a first open end;
a feeding radiator bendably connected to the main radiator;
a first grounding radiator bendably connected to the main radiator;
a first tilting radiator bendably connected to the main radiator, and having a second open end away from the main radiator, wherein the first tilting radiator is located at an opposite side relative to the first grounding radiator and the feeding radiator, and a first non-zero angle is formed between the first tilting radiator and a normal direction of the main radiator;
a second grounding radiator bendably connected to the main radiator, and located at an opposite side relative to the first open end; and
a pattern adjusting radiator located beside the first open end and separated from the first open end, wherein the pattern adjusting radiator comprises a matching radiator and a second tilting radiator connected to each other, the matching radiator is close to the first open end, and a second non-zero angle is formed between the second tilting radiator and the normal direction.

2. The antenna module as claimed in claim 1, wherein the antenna module resonates at a first frequency, and a path length from the second open end, the main radiator to the first grounding radiator is two-quarters wavelength of the first frequency.

3. The antenna module as claimed in claim 1, wherein the antenna module resonates at a second frequency, and a path length from the first open end, the main radiator to the second grounding radiator is three-quarters wavelength of the second frequency.

4. The antenna module as claimed in claim 1, wherein the second tilting radiator is grounded at a location away from the matching radiator.

5. The antenna module as claimed in claim 1, wherein the first non-zero angle and the second non-zero angle are different or same, and each of the first non-zero angle and the second non-zero angle is less than 90 degrees.

6. The antenna module as claimed in claim 1, wherein a distance between the matching radiator and the first open end is greater than 0 centimeter and less than 3 centimeters.

7. The antenna module as claimed in claim 1, wherein the main radiator is polygonal, circular, or elliptical.

8. The antenna module as claimed in claim 1, wherein the main radiator is rectangular and comprises a first side, a second side, a third side, and a fourth side sequentially connected, the first open end is located at the first side, the feeding radiator and the first grounding radiator are connected to the second side, the second grounding radiator is connected to the third side, and the first tilting radiator is connected to the fourth side.

9. The antenna module as claimed in claim 1, wherein the feeding radiator, the first grounding radiator, and the second grounding radiator are perpendicular to the main radiator, and the first grounding radiator is perpendicular to the second grounding radiator.

10. The antenna module as claimed in claim 1, wherein the frequency band resonated by the antenna module is in a range of 3.3 GHz to 4.2 GHz.
